(19) United States
(12) Patent Application Publication
(10) Pub. No.: US 2003/0062717 A1
(43) Pub. Date: Apr. 3, 2003

(54) Multi-passage conduit

(75) Inventors: Wayne Thomas, Calgary (CA); Gary Morcom, Calgary (CA)

Correspondence Address: BLAKE, CASSELS & GRAYDON LLP, BOX 25, COMMERCE COURT WEST, 199 BAY STREET, SUITE 2800, TORONTO, ON, M5L 1A9, CA

(73) Assignee: PanCanadian Petroleum Limited

(21) Appl. No.: 10/207,382

(22) Filed: Jul. 30, 2002

Related U.S. Application Data
(63) Continuation of application No. 09/584,366, filed on Jun. 1, 2000, now abandoned.

(51) Int. Cl. F16L 35/00

(52) U.S. Cl. 285/18; 285/124.1; 285/124.2

(57) ABSTRACT

A well production apparatus includes a down-hole gear pump and a transport assembly to which the gear pump is attached. The transport assembly is formed from a string of modular pipe assemblies having one or more passages for carrying production fluid from the bottom of the well to the surface. The passages can be arranged in a side-by-side configuration, and include pressure and return lines such as used to drive a hydraulic motor connected to the gear pump. The modular pipe assemblies can have two, three, four, or more passages, and can be stepped relative to each other to give a unique assembly orientation. The modular assemblies have mating fitting that can be tightened without the need to spin the pipe joints at the same time.

### FIELD OF THE INVENTION

This invention relates generally to the field of well production apparatus such as used, for example, in down-hole pumping systems in wells.

### BACKGROUND OF THE INVENTION

In a number of applications, such as oil or other wells, it is desirable to conduct one or more types of fluid down a long tube, or string of tubing, while conducting another flow, or flows, in the opposite direction. Similarly, it may be advantageous to use a passageway, or a pair of passageways to conduct one kind of fluid, and another passageway for electrical cabling whether for monitoring devices or for some other purpose, or another pair of passageways for either pneumatic or hydraulic power transmission. In oil field operations it may be desirable to have a pair of passageways as pressure and return lines for hydraulic power, another line, or lines, for conveying production fluids to the surface, perhaps another line for supplying steam, and perhaps another line for carrying monitoring or communications cabling.

One method of achieving this end is to use concentrically nested pipes, the central pipe having a flow in one direction, the annulus between the central pipe and the next pipe carrying another flow, typically in the opposite direction. It may be possible to have additional annulli carrying yet other flows, and so on. Although singular continuous coiled tubing has been used, the ability to run an inner string within an outer concentric string is relatively new, and may tend to be relatively expensive. This has a number of disadvantages, particularly in well drilling. Typically, in well drilling the outside diameter of the pipe is limited by the size of the well bore to be drilled. This pipe size is all the more limited if the drilling is to penetrate into pockets of liquid or gas that are under pressure. In such instances a blow-out preventer (BOP) is used, limiting the outside diameter of the pipe. Typically, a drill string is assembled by adding modules, or sections of pipe, together to form a string. Each section is termed a “joint”. A joint has a connection means at each end. For example, one end (typically the down-hole end) may have a male coupling, such as an external thread, while the opposite, well-head, end has a matching female coupling, such as a union nut. It is advantageous in this instance to have a positive make-up, that is, to be able to join the “joints” without having to spin the entire body of the joint, but rather to have the coupling rotate independently of the pipe.

A limit on the outside diameter of the external pipe casing imposes inherent limitations on the cross-sectional area available for use as passageways for fluids. In some instances three or four passages are required. For example, this is the case when a motive fluid, whether hydraulic oil or water, is used to drive a motor or pump, requiring pressure and return lines, while the production fluid being pumped out requires one or more passages. The annulus width for four passages nested in a 3.5 inch tube is relatively small. The inventors are unaware of any triple or quadruple concentric tube string that has been used successfully in field operations.

As the depth of the well increases, the downhole pressure drop in the passages also increases. In some cases the well depth is measured in thousands of metres. The pressure required to force a slurry, for example, up an annular tube several kilometres long, may tend to be significant. One way to reduce the pressure drop is to improve the shape of the passages. For example, in the limit as an annulus becomes thin relative to its diameter, the hydraulic diameter of the resultant passage approaches twice the width, or thickness, of the annulus. For a given volumetric flow rate, at high Reynolds numbers pipe losses due to fluid friction vary roughly as the fourth power of diameter. Hence it is advantageous to increase the hydraulic diameter of the various passageways. One way to increase the hydraulic diameter of the passage is to bundle a number of tubes, or pipes, in a side-by-side configuration within an external retainer or casing in place of nested annulli. The overall cross-sectional area can also be improved by dividing the circular area into non-circular sectors, such as passages that have the cross-section shape of a portion of a pie.

Another important design consideration in constructing a pipe for deep well drilling, or well drilling under pressure, is that the conduit used be suitable for operation in a blow out preventer. This means that the pipe must be provided in sections, or joints, that can be assembled progressively in the blow out preventer to create, eventually, a complete string thousands, or tens of thousands, of feet long. It is important that the sections fit together in a unique manner, so that the various passages align themselves—it would not do for an hydraulic oil power supply conduit of one section to be lined up with the production fluid upward flow line of an adjacent section. Further, given the pressures involved, not only must the passage walls in each section be adequate for the operational pressure to which they are exposed, but the sections of pipe must have a positive seal to each other as they are assembled. Further still, given the relatively remote locations at which these assemblies may be used, and possibly harsh environmental conditions, the sections must go together relatively easily. It is advantageous to have a “user friendly” assembly for ease of pick-up, handling, and installation, that can be used in a conventional oil rig, for example.

Some of the tube passages must be formed in a manner to contain significant pressure. For an actual operating differential pressure in the range of 0-2000 p.s.i. it may be desirable to use pipe that can accommodate pressures up to, for example, 8,000 p.s.i. seamless steel pipe can be obtained that is satisfactory for this purpose. Electrical resistance welded pipe (ERW) that is suitable for this purpose can also be obtained. The steel pipe can then be roll formed to the desired cross-sectional shape.

### SUMMARY OF THE INVENTION

In an aspect of the invention there is a modular well pipe assembly. There is a pipe wall structure having at least first and second passages defined side-by-side therein. The pipe wall structure has a first end and a second end. The first and second ends have respective first and second end couplings matable with other end couplings of modular pipe assemblies of the same type. The end fittings have alignment fittings for aligning the first and second passages with corresponding first and second passages in other modular pipe assemblies of the same type.

In an additional feature of that aspect of the invention, the pipe wall structure includes a hollow outer casing and at least first and second conduits for carrying fluids mounted side-by-side within the casing. In another additional feature of that aspect of the invention, one of the end couplings has a seal mounted thereto. The seal has porting defined therein corresponding to the passages. The seal is placed to maintain segregation between the passages when the modular pipe assembly is joined to another modular pipe assembly of the same type. In yet another additional feature, the end coupling is engageable with a mating modular pipe assembly to compress the seal.

In still another additional feature, the pipe wall structure includes a first conduit member and a second conduit member mounted within the first conduit member. The first conduit member has a continuous wall. The continuous wall has an inner surface defining a periphery of an internal space. The second conduit member occupies a first portion of the internal space of the first conduit member and leaves a remainder of the internal space of the first conduit member. The second conduit member has a continuous wall. The continuous wall of the second conduit member has the second side by side passage defined therewithin. The continuous wall of the second conduit has an external surface. A portion of the external surface of the second conduit member is formed to conform to a first portion of the inner surface of the first conduit member, and being located thereadjacent. The first passage is defined within the remainder of the internal space of the first conduit member. In still yet another additional feature, the inner surface of the first conduit member has a second portion bounding a portion of the first passage.

In another additional feature of that aspect of the invention, the inner surface of the first conduit member has a second portion. The external surface of the second conduit member has a second portion. The second portion of the inner surface of the first conduit member and the second portion of the external surface of the second conduit member co-operate to bound at least a portion of the first passageway. In yet another additional feature of that aspect of the invention, the first conduit member has a round cylindrical cross-section. The second conduit member continuous wall has a portion lying along a first chord of the cylindrical cross-section. In still another additional feature, the chord is a diametrical chord. In another additional feature, the second conduit member has another portion lying along a second chord of the cylindrical cross-section. In a further additional feature of that aspect of the invention, the second conduit member occupies a sector of the cylindrical cross-section between the first and second chords.

In yet a further additional feature, the pipe wall structure includes a third conduit member. The third conduit member has a continuous wall having a third side-by-side passage defined therewithin. The third conduit member has an external surface. A portion of the external surface is shaped to conform to, and is located adjacent to a second portion of the inner surface of the first conduit member.

In still a further additional feature, the pipe wall structure includes a third conduit member. The third conduit member has a continuous wall having a third side-by-side passage defined therewithin. The second conduit member has an internal wall surface. The third conduit member continuous wall has an external surface. A portion of the external surface of the third conduit member is shaped to conform to, and is mounted against, a portion of the internal wall surface of the second conduit member.

In another additional feature of that aspect of the invention, the pipe wall structure includes a first conduit member, a second conduit member, and a third conduit member. The second and third conduit members are mounted side-by-side within the first conduit member. In yet another additional feature, the second conduit member has a circular cross-section. In still another additional feature, the second and third conduit members have circular cross-sections. In a further additional feature, a fourth conduit member is mounted within the first conduit member. In still a further additional feature, the first conduit member has a circular internal wall surface. The second, third and fourth conduit members have circular cross sections and are mounted in tangential engagement with the circular internal wall surface of the first conduit member. In another additional feature of that aspect of the invention, each of the second, third and fourth conduit members is tangent to at least one of the others. In still another additional feature, at least one of the second and third conduit members is hexagonal in cross-section.

In yet another additional feature, at least one of the second and third conduit members is pie shaped in cross-section. In a further feature of that aspect of the invention, the pie shape is chosen for the set of pie shapes consisting of (a) a half of a pie; (b) a third of a pie; (c) a quarter of a pie; and (d) a sixth of a pie.

In another feature of that aspect of the invention, the pipe wall structure includes a first conduit member and a second conduit member mounted within the first conduit member. The second conduit member has a continuous wall bounding the second passage. The second passage has a periphery and a cross-sectional area. The second conduit member continuous wall has an internal surface defining the periphery of the second passage. The second passage has a hydraulic diameter that is less than the dividend obtained by dividing the perimeter by π. In another additional feature, the second conduit member is free of convex portions.

In another additional feature of that aspect of the invention, the pipe wall structure includes a first conduit member and a second conduit member mounted within the first conduit member. The second passage has a perimeter ‘P’, a cross-sectional area A and a hydraulic diameter D_{H}. The second conduit member has a continuous wall having an inside surface defining the perimeter ‘P’ of the second passage and A<(P²/4π). In still another additional feature, the second conduit member is free of convex portions.

In yet another additional feature, the pipe wall structure includes a first, outer, conduit member having an inner wall surface and a second, inner, conduit member mounted within the first conduit member. The inner conduit member has an outer wall surface. The inner wall surface of the outer conduit member and the outer wall surface of the inner conduit member bounds a region intermediate the outer conduit member and the inner conduit member. A third conduit member defines a third passage therewithin in side-by-side relationship to the second passage. The third conduit member is located in the region intermediate the inner wall surface of the outer conduit member and the outer wall surface of the inner conduit member.

In another additional feature of that aspect of the invention, the third conduit member has an outer wall surface. The outer wall surface of the third conduit member has a first portion engaging the inner wall surface of the outer conduit member and a second portion engaging the outer wall surface of the inner conduit member. In still another additional feature, the first portion of the third conduit member is shaped to conform to a portion of the inner wall surface of the outer conduit member. The second portion of the third conduit member is shaped to conform to a portion of the outer wall surface of the inner conduit member. In yet another additional feature, the region between the outer and inner conduits is annular. In another additional feature, the inner conduit member is concentric to the outer conduit member. In yet another additional feature, an annulus is defined between the inner and outer conduit members and the third conduit member occupies a sector of the annulus. In another additional feature of that aspect of the invention, a plurality of conduit members each occupy sectors of the annulus.

These and other aspects and features of the invention are described herein with reference to the accompanying illustrations.

### BRIEF DESCRIPTION OF THE DRAWINGS

FIG. 1a shows a general schematic illustration of a steam assisted gravity drainage oil productions system having a down-hole production unit;

FIG. 1b shows a schematic illustration of the down-hole production unit of FIG. 1a.

FIG. 2a shows a side view of an assembled multi-passage pipe assembly according to an aspect of the present invention;

FIG. 2b shows an isometric view of a pair of the multi-passage pipe assemblies of FIG. 2a joined together;

FIG. 2c shows an exploded isometric view of the pair of multi-passage pipe assemblies of FIG. 2b in a separated condition;

FIG. 2d is a cross-sectional view of the pipe assemblies of FIG. 2a showing the join;

FIG. 3a is an isometric view of a tube member of the multi-passage pipe assembly of FIG. 2a;

FIG. 3b is a cross-sectional view of the tube member of FIG. 3a;

FIG. 4a is a plan view of a seal for the pipe assemblies of FIG. 2a;

FIG. 4b is a diametral cross-section of the seal of FIG. 4a;

FIG. 4c is a detail of a portion of the cross-section of the seal of FIG. 4b;

FIG. 5a shows an isometric view of an alternate assembly to that of FIG. 2a;

FIG. 5b is a detail view of a seal for the assembly of FIG. 5a;

FIG. 5c is a detail of a portion of the assembly of FIG. 5a as assembled;

FIG. 6a is a plan view of a seal retainer for the pipe assemblies of FIG. 5a;

FIG. 6b is a side view of the seal retainer of FIG. 6a;

FIG. 6c is a detail of a cross-section of the seal retainer of FIG. 6a;

FIG. 7a is a plan view of a seal for the pipe assemblies of FIG. 5a;

FIG. 7b is a diametral cross-section of the seal of FIG. 7a;

FIG. 7c is a detail of a portion of the cross-section of the seal of FIG. 7b ;

FIG. 7d is a plan view of an alternative seal for the assembly of FIG. 5a;

FIG. 7e is a diametral cross-section of the seal of FIG. 7d;

FIG. 7f is a detail of a portion of the cross-section of the seal of FIG. 7e;

FIG. 8a shows a cross-sectional view of the tube assembly of FIG. 2a taken on section ‘8a-8a’;

FIG. 8b shows a cross-sectional view of an alternate tube assembly to that of FIG. 8a having a pair of semi-circular tubes mounted side-by-side;

FIG. 8c shows a cross-sectional view of an alternate tube assembly to that of FIG. 8a, having three passages, one being larger than the other two;

FIG. 8d shows a cross-sectional view of an alternate tube assembly to that of FIG. 8b, having two tubes, one being larger than the other, the tubes meeting on a chord of a circle offset from the diametral plane;

FIG. 8e shows a cross-sectional view of an alternate tube assembly to that of FIG. 8d, having two tubes, one being larger than the other two, the tubes meeting on radial planes;

FIG. 9a shows a cross-sectional view of an alternate tube assembly to that of FIG. 8a, having three equal sized passages with radially extending webs;

FIG. 9b shows a cross-sectional view of an alternate tube assembly to that of FIG. 8a, having three unequal tubes with radially extending webs;

FIG. 10a shows a cross-sectional view of an alternate tube assembly to that of FIG. 8a, having six equal pie shaped passages;

FIG. 10b shows a cross-sectional view of an alternate tube assembly to that of FIG. 8a, having seven hexagonal tubes;

FIG. 11a shows a cross-sectional view of an alternate tube assembly to the tube assembly of FIG. 8c, in which the largest passage occupies more than half the tube area;

FIG. 11b is similar to FIG. 11a, but shows a tube assembly having three tubes, and in which one tube occupies a minor sector of the tube area;

FIG. 11c shows a cross-sectional view of an alternate tube assembly to that of FIG. 8a, having two unequal pairs of tubes with non-radial webs;

FIG. 11d shows a cross-sectional view of an alternate tube assembly to that of FIG. 8a, having four unequal tubes;

FIG. 12a shows a cross-sectional view of an alternate tube assembly to that of FIG. 8a, having two round tubes within a round casing;

FIG. 12b shows a cross-sectional view of an alternate tube assembly to that of FIG. 8a, having three round tubes within a round casing;

FIG. 12c shows a cross-sectional view of an alternate tube assembly to that of FIG. 8a, having four round tubes bundled within a circular outer wall;

FIG. 13a shows a cross-sectional view of an alternate tube assembly to that of FIG. 8a, having two equal outer tubes arranged about a central tube;

FIG. 13b shows a cross-sectional view of an alternate tube assembly to that of FIG. 8a, having two unequal outer tubes arranged about a central tube;

FIG. 14a shows a cross-sectional view of an alternate tube assembly to that of FIG. 8a, having three equal outer tubes arranged about a central tube;

FIG. 14b shows a cross-sectional view of an alternate tube assembly to that of FIG. 14a, having three unequal outer tubes arranged about a central tube;

FIG. 15a shows a cross-sectional view of an alternate tube assembly to that of FIG. 8a, having four equal outer tubes arranged about a central tube;

FIG. 15b shows a cross-sectional view of an alternate tube assembly to that of FIG. 8a, having four outer tubes, one larger than the others, arranged about a central tube;

FIG. 15c shows a cross-sectional view of an alternate tube assembly to that of FIG. 8a, having four unequal outer tubes arranged about a central tube;

FIG. 16a shows a cross-sectional view of an alternative pipe assembly to that of FIG. 8a having a semi-circular tube nested within a circular tube;

FIG. 16b shows a cross-sectional view of an alternate pipe assembly to that of FIG. 16a, having two pie shaped side-by-side tubes nested within a circular tube;

FIG. 16c shows a cross-sectional view of an alternate pipe assembly to that of FIG. 16a, having three pie shaped side-by-side tubes nested within a circular tube;

FIG. 16d shows a cross-sectional view of an alternate pipe assembly to that of FIG. 16a, having two circular side-by-side tubes nested within a circular tube;

FIG. 16e shows a cross-sectional view of an alternate pipe assembly to that of FIG. 16a, similar to that of FIG. 13a, but having one of the non-circular tubes removed;

FIG. 17a shows a cross-sectional view of an alternate pipe assembly to that of FIG. 16a, having a pie shaped tube nested within a semi-circular tube, nested within a circular tube;

FIG. 17b shows a cross-sectional view of an alternate pipe assembly to that of FIG. 17a, having a pair of pie shaped tubes nested side-by-side within a semi-circular tube, nested within a circular tube; and

FIG. 18 shows cross-sectional views of extruded pipe assembly cross-sections providing alternatives to the pipe assembly of FIG. 8a.

### DETAILED DESCRIPTION OF THE INVENTION

The description which follows, and the embodiments described therein, are provided by way of illustration of an example, or examples of particular embodiments of the principles of the present invention. These examples are provided for the purposes of explanation, and not of limitation, of those principles and of the invention. In the description which follows, like parts are marked throughout the specification and the drawings with the same respective reference numerals. The drawings are not necessarily to scale and in some instances proportions may have been exaggerated in order more clearly to depict certain features of the invention.

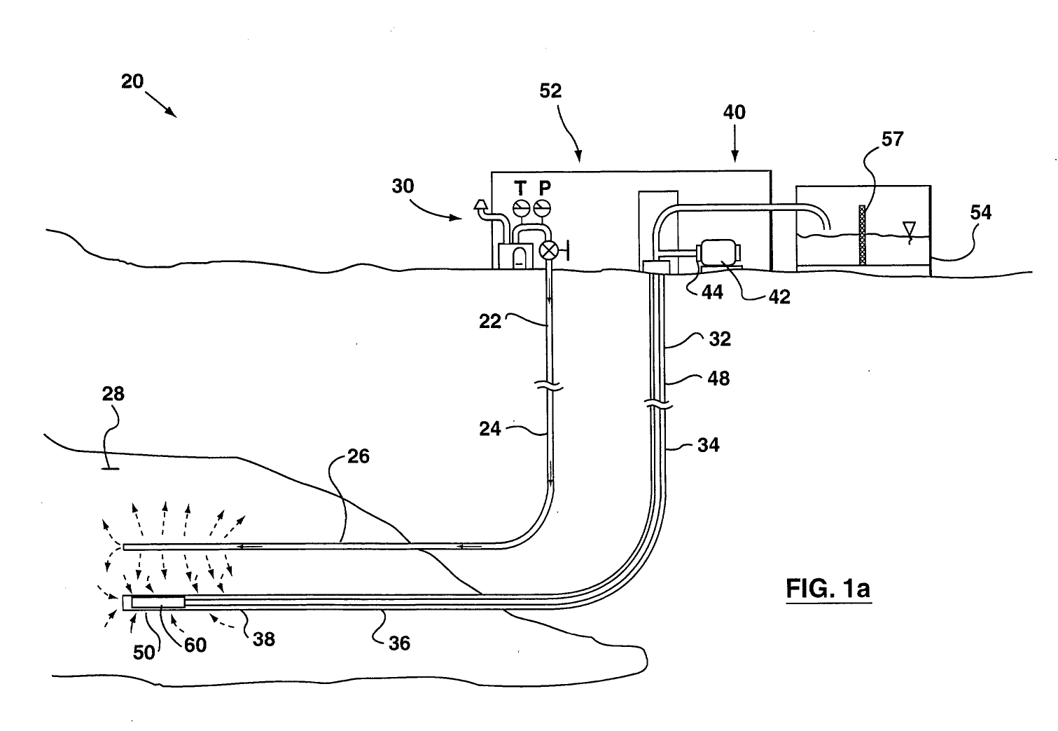

By way of a general overview, an oil extraction process apparatus is indicated generally in FIG. 1a as 20. It includes a first bore 22 having a vertical portion 24 and a horizontal portion 26. Horizontal portion 26 extends into an oil bearing formation 28 at some distance below the surface. For the purposes of illustration, the vertical scale of FIG. 1 is distorted. The actual depth to horizontal portion 26 may be several kilometres. A steam generating system 30 is located at the well head and is used to inject steam at temperature T and pressure P down bore 22. Horizontal portion 26 is perforated to permit the steam to penetrate the adjacent regions of formation 28.

A second well bore is indicated as 32. It has a vertical portion 34 and a horizontal portion 36, corresponding generally to vertical portion 24 and horizontal portion 26 of bore 22. Horizontal portion 36 runs generally parallel to, and somewhat below, horizontal portion 26. A section (or sections) 38 of horizontal portion 36 runs through oil bearing formation 28, and is perforated to permit production fluid to drain from formation 28 into section 38. The injection of steam into formation 28 through portion 26 is undertaken to encourage drainage of oil from formation 28. It will be appreciated that alternative types of well can also have analogous vertical or inclined perforated sections.

A production fluid lift system in the nature of a pumping system is designated generally as 40. It is shown schematically in FIG. 1b. It includes a power generation system 42 at the well head, in the nature of a motor 44 that drives a hydraulic pump 46. A transport system 48 carries power transmitted from system 42 to the downhole end 50 of bore 32, and carries production fluid from downhole end 50 to the well head 52. A collection and separation system, such as a holding tank 54 is located at the well head to receive the production fluid as it exits transport system 48. A hydraulic reservoir 56 receives returned hydraulic fluid HF, and has a sump whence hydraulic fluid is again drawn into hydraulic pump 46. Respective filters are indicated as 57 and 59.

Transport system 48 terminates at a downhole production unit 60. Production unit 60 includes a power conversion unit, namely a hydraulic motor section 62, that is driven by the pressurized hydraulic fluid (such as water) carried in pressure line 65 and return line 66 by transport system 48 from and to hydraulic pump 46 to convert the transported power to a mechanical output, namely torque T in a rotating output shaft. Production unit 60 also includes a pump section 64 that is driven by hydraulic motor 62, pump section 64 being operable to urge production fluids PF to the surface by way of production fluid lift line 68 through transport system 48. A blow out preventer indicated as BOP, engages transport system 48 at well head 52 since the well pressure, and temperature, may be well above atmospheric.

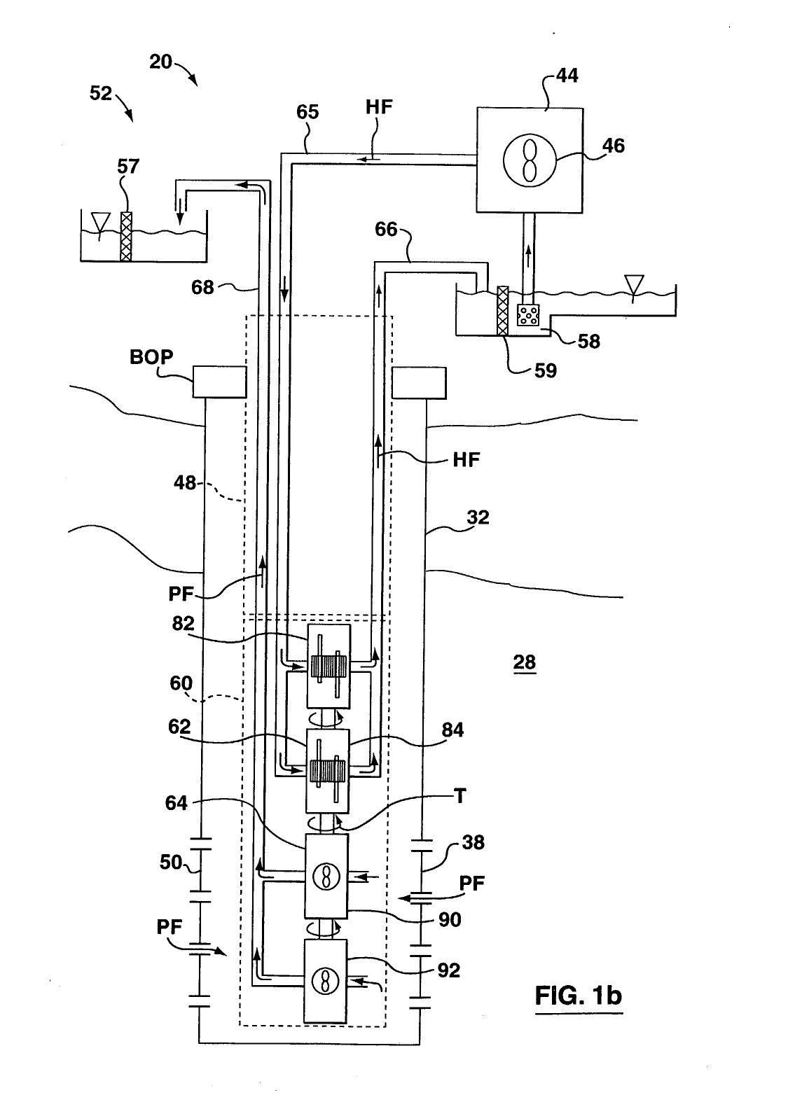

Operation of the foregoing preferred and alternative embodiments of production units and their associated motor or pump units requires a supply of hydraulic fluid, and transport of the production fluid to the surface. To that end, transport system 48 employs a multi-passage conduit that is now described in greater detail. By way of a general overview, and referring to FIGS. 2a, 2b, and 2c, a pipe string “joint” in the nature of a modular pipe assembly is shown as 520. It has a casing 522 and an interconnection in the nature of a male fitting 524 at one end, and a female fitting in the nature of a female coupling 526 at the other, such that a string of modular pipe assemblies 520 can be joined together. A pipe bundle 528 is contained within casing 522, and a seal 530 of matching profile to bundle 528 is clamped between adjacent assemblies 520 when a string is put together. Notably, the pipes of bundle 528 lie side by side, rather than being nested concentrically one within the other. For the purposes of illustration, the length of the assembly or assemblies shown is shorter in the illustrations than in actual fact. In use a typical assembly length would be 10 or 12 m (32.8 to 39.5 ft), and the pipe bundle diameter would be about 15 cm (6 in.). Other lengths and diameters can be used. The longitudinal, or axial direction is indicated in the figures by center line axis CL of casing 522.

During deployment or installation, pipe assembly 520 is mounted to another pipe assembly, then introduced into a well bore a few feet, another similar section of pipe is added, the string is advanced, another string is added and so on. Although assembly 520 can be used in a horizontal well bore application, the assembly at the well head is generally in the vertical orientation. Thus FIGS. 2a, 2b, and 2c each have arrows indicating “Up” and “Down” such as well rig workers would see at the well head.

Examining the Figures in greater detail, casing 522 is round and cylindrical and serves as an external bundle retainer. It is preferred that casing 522 be shrink fit about bundle 528. In the preferred embodiment of FIG. 2a, casing 522 is made from mild steel pipe. The type of material used for the casing may tend to depend on the application. For example, a stainless steel or other alloy may be preferred for use in more aggressive environments, such as high sulfur wells. Casing 522 has a pair of first and second ends, 534 and 536. Male fitting 524 is mounted at first end 534. Female coupling 528 is mounted about casing 522, and is longitudinally slidable and rotatable with respect to second end 536. A retaining ring 542 is mounted flush with second end 536, and a start flange, 544, is mounted inboard of ring 542. Start flange 544 is a cylindrical collar having one turn of a single external thread 545. As shown in FIG. 2c, first and second indexing dogs 546 and 548, protrude longitudinally, or axially, from first and second ends 524 and 526 respectively. At corresponding positions indicated by arrows 550 and 552, assembly 520 has sockets into which dogs of other mating pipe assemblies can locate. During assembly of a string of pipes at the well head, dogs 546 and 548 engage matching sockets in the next adjacent assemblies, thus ensuring their relative alignment as the string is assembled.

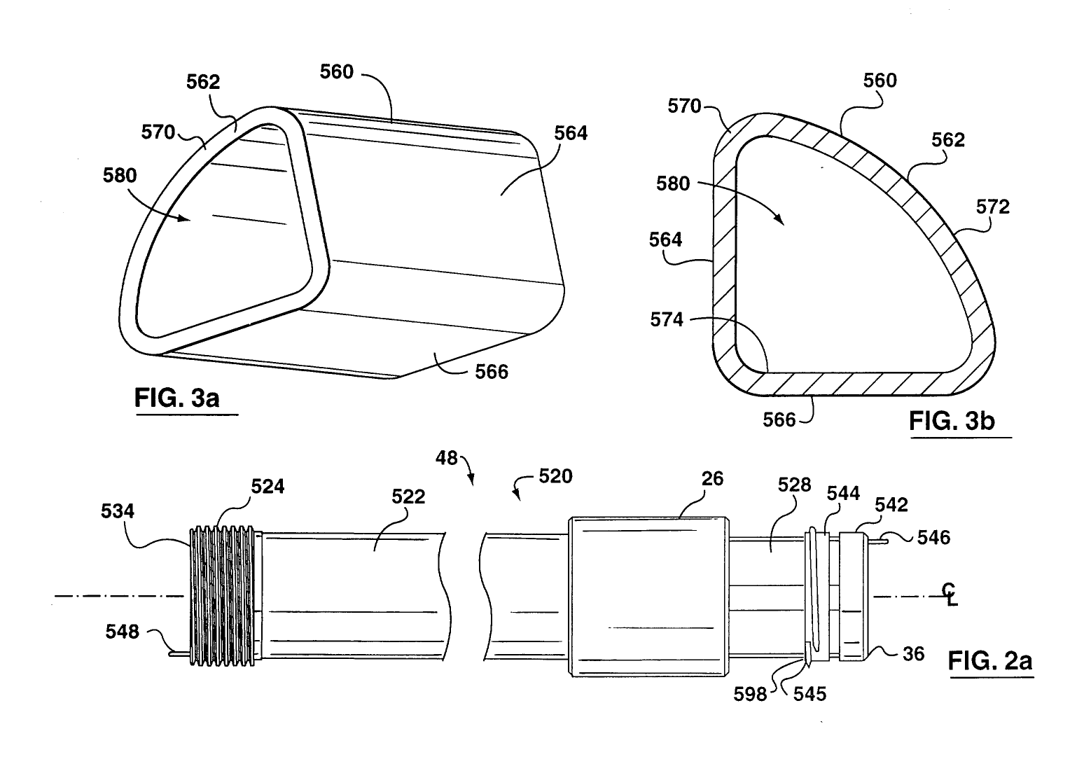

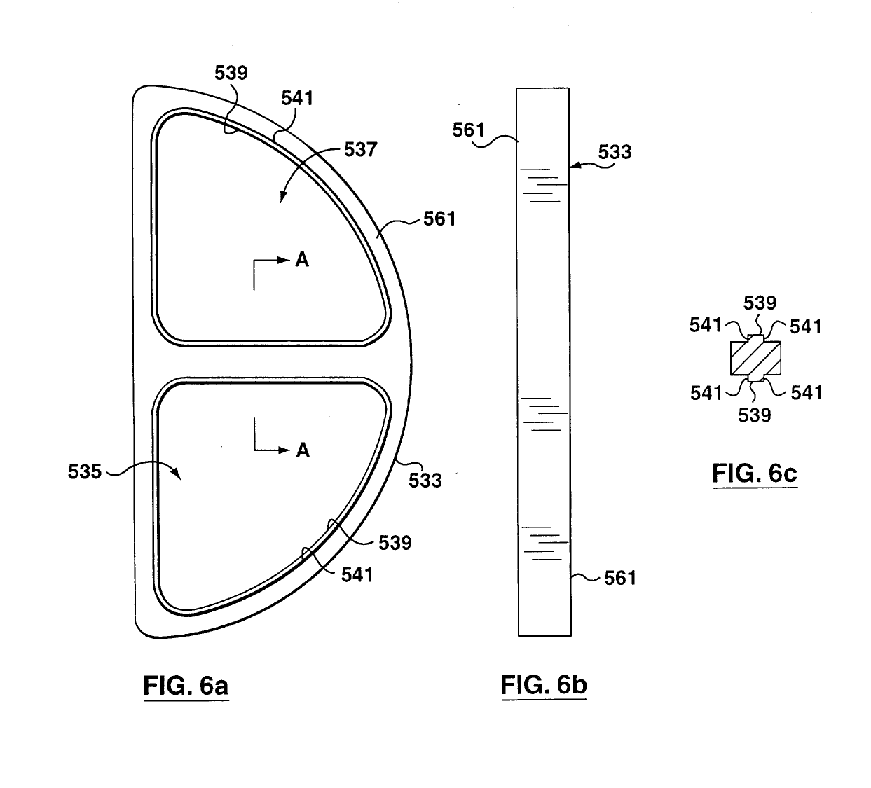

As shown in FIGS. 2b and 2c, each of pipe assemblies 520 has four parallel conduit members, or pipe sections, in the nature tubes, 554, 556, 558 and 560 arranged in a bundle within casing 522. In the FIGS. 2b and 2c all of tubes 554, 556, 558 and 560 have the same cross-section, being that shown in FIGS. 3a and 8a. That section has the shape of a right angle sector of a circle, that is, a pie-shaped piece approximating a quarter of a pie, with smoothly radiused corners. In the preferred embodiment of FIGS. 3a and 8a, tube 560 has an outer arcuate portion 562, having an outside radius of curvature of 2.75 inches to suit a pipe having an inside, shrink fit diameter of 5.5 inches. Tube 560 also has a first side 564, and a second side 566 at right angles to first side 564. Arcuate portion 562 and sides 564 and 566 are joined at their respective common vertices to define a closed wall section, 570. Section 570 has an external wall surface 572, and an internal wall surface 574, each having respective first and second straight portions and an arcuate portion, with radiused corners.

Section 570 is made by roll forming a round pipe of known pressure rating into irregular pie shape shown. This can be done in progressive roll forming stages. Section 570 is a seamless pipe. Other types of pipe can also be used, such as seamed ERW pipe, or an extruded pipe capable of holding the pressures imposed during operation.

Internal wall surface 574 defines a passageway, indicated generally as 580, along which a fluid can be conveyed in the axial, or longitudinal direction, whether upward or downward. When casing 522 is shrunk fit in place, tubes 554, 556, 558 and 560 have a combined outer surface approximating a circle and are held in place against each other's respective first and second external side portions by friction.

In the cross-section of FIG. 2d, a pair of assemblies 520 are shown as connected in an engaged or coupled position. Female coupling 526 has a circular cylindrical body 582 having an internal bore 584 defined therewithin. At one end body 582 has an end wall 583 having an opening 585 defined centrally therein, opening 585 being sized to fit closely about casing 522. At the other end body 582 has a cylindrical land 586 that has an internal thread 588 for mating engagement with the external male thread 590 of male fitting 524 of an adjacent assembly 520.

Body 582 also has an internal relief 592 defined therein. Relief 592 is bounded by a first shoulder 594, on its nominally upward end. As assembled, first shoulder 594 bears against the upward facing annular end face 598 of start flange 544, and, as female internal thread 588 engages male external thread 590, the upper and lower assemblies 520 are drawn together, compressing seal 530 in the process.

When the upper and lower assemblies 520 are not joined together, female coupling 526 is backed off such that the first turn of internal thread 588 downstream of relief 592 engages the single external thread 545 of start flange 544. This results in female coupling 526 being held up at a height to permit a well worker to make sure that seal 530 is in place on the downward assembly 520, and indexed correctly relative to dogs 546 and 548, before the two units are joined together.

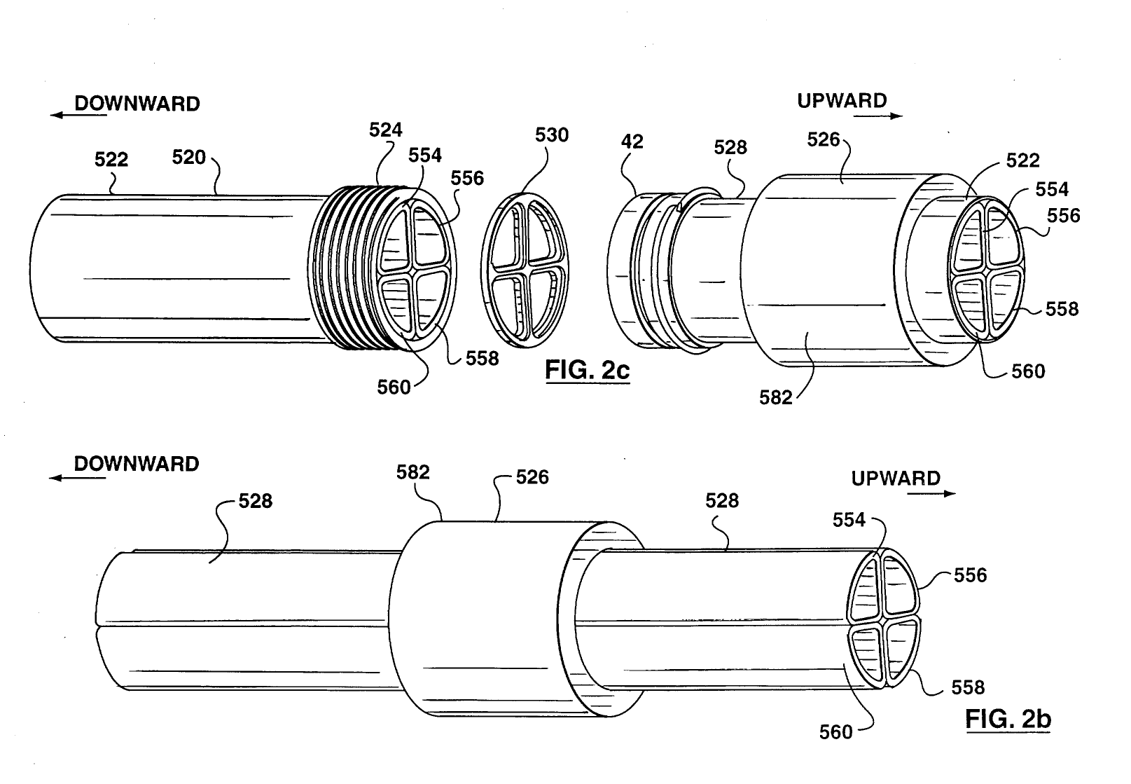

Seal 530 is shown in plan view in FIG. 4a. It has a circular external circumference 602, with first and second dog locating notches 604 and 606 shown diametrally opposed from each other, notches 604 and 606 acting as alignment governors, or indexing means. When located on the end of a pipe assembly 520, notch 604, for example, locates on dog 546, and when two such pipe assemblies are joined, the other dog, namely dog 548 of the second pipe assembly, will locate in the opposite notch, namely notch 606. Although the preferred embodiment is shown in FIG. 4a, the notches need not be on 180 degree centers, but could be on an asymmetric, or offset 90 degrees, such as may be suitable for ensuring that the dogs line up as indexing devices to ensure that adjoining sections of pipe, when assembled have the correct passages in alignment. Seal 530 has four quarter pie shaped openings 610, 612, 614, and 616 defined on 90 degree centers, such as correspond to the general shape of the cross-section of passageway 580 of each of tubes 554, 556, 558 and 560. With these openings so defined, seal 530 is left with a four-armed spider 615 in the form of a cross. A fifth, rather smaller, generally square aperture 618, is formed centrally in spider 615, such as may be suitable for permitting the passage of electrical wires for a sensing or monitoring device. As can be seen in the sectional view of FIGS. 4b and 4c, seal 530 has grooves 620 and 622 formed on opposite sides (that is, front and back, or upper and lower as installed), each of grooves 620 and 622 having the shape, in plan view, to correspond to the shape of a protruding lip of the end of each of tubes 554, 556, 558 and 560. The mating shapes locate positively, again ensuring alignment, and, when squeezed under the closing force or female coupling 526, a seal is formed, tending to maintain the integrity, that is, the segregation, of the various passageways from pipe to pipe as the string is put together.

The approximate centroids of the passages of tubes 554, 556, 558, and 560 are indicated as 600. It will be noted that unlike nested pipes, whether concentric or eccentric, none of the passages defined within any or the respective pipes is occluded by any other pipe, and none of the centroids of any of the pipes fall within the profiles of any of the other pipes. Put another way, the hydraulic diameter of each of the pipes is significantly greater than the hydraulic diameter that would result if four round cylindrical tubes were nested concentrically, one inside the other, with equivalent wall thicknesses. The useful area within casing 522 may also tend to be greater since the sum of the peripheries of the tubes, multiplied by their thickness may tend to yield a lesser area than the wall cross-sectional area of four concentric pipes.

The embodiment of FIG. 8a is currently preferred. Such an embodiment has a number of advantages. First, all of the pipe segments are of the same cross-section, which simplifies manufacture, assembly and replacement. Second, in an application where the multi-passage conduit assembly so obtained is used to drive a down-hole hydraulic pump, one passage can be use to carry hydraulic fluid under pressure, another passage can be used to carry the hydraulic fluid return flow, a third passage can carry the production fluid that is to be pumped out of the well, and the fourth passage or the central gap can be used for electrical cabling, such as may be required for monitoring equipment.

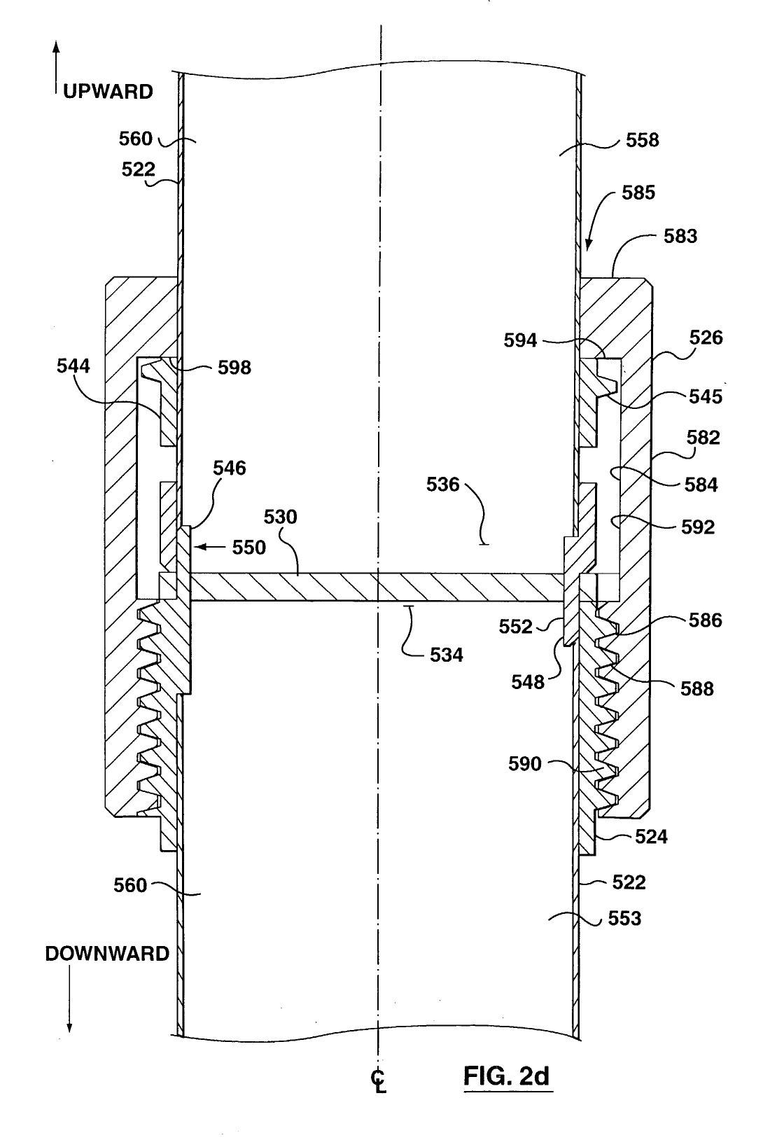

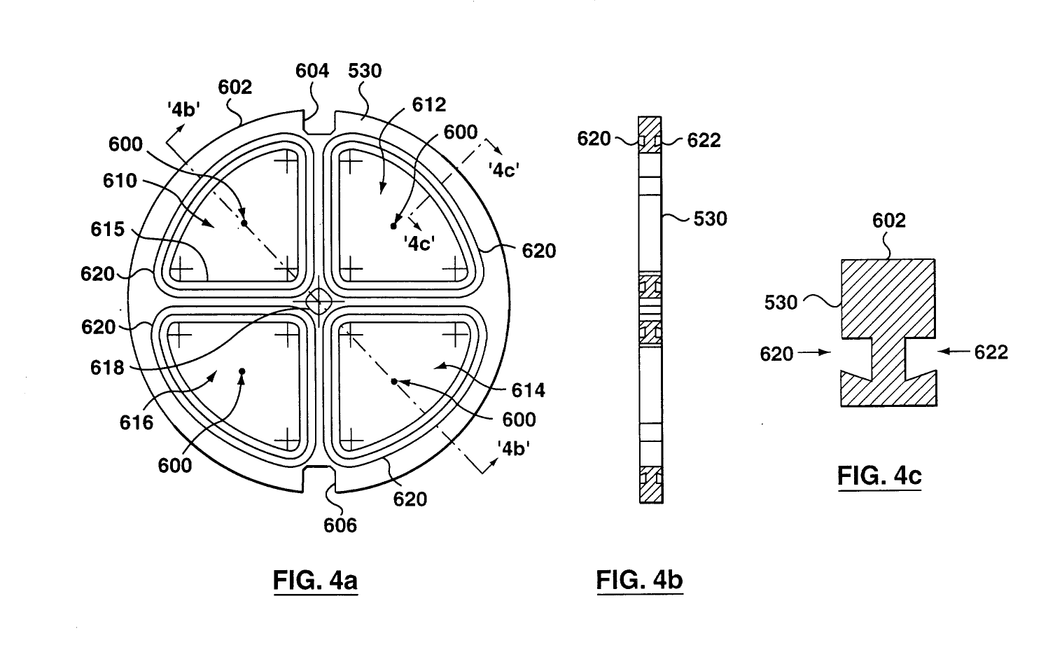

FIGS. 5a to 5c show an alternative embodiment to pipe assembly 520, namely pipe assembly 521. As above, the general arrangement of quarter-pie shaped tubes, the use of retaining collars, and the use of male and female fitting to draw adjacent pipe joints together is generally as described above. Assembly 521 differs from assembly 520 in that one pair of the pie shaped pipes 525 is longitudinally stepped relative to another pair 527, permitting the elimination of dogs 546 and 548. To accommodate this step, each of pairs 525 and 527 is provided, at its joining interface with a corresponding adjacent pair of an adjacent pipe joint, with a pair of seals 529, 531, and a seal retainer 533. In the example shown in FIGS. 5a, 5b, 6a, 6b and 6c, seal retainer 533 is a frame having a semi-circular shape, in plan view, with a pair of quarter-pie shaped openings 535, 537 defined therein. The peripheral wall of each of openings 535 and 537 has an inwardly protruding medial rib, or ridge, 539 having upward and downward facing shoulders 541.

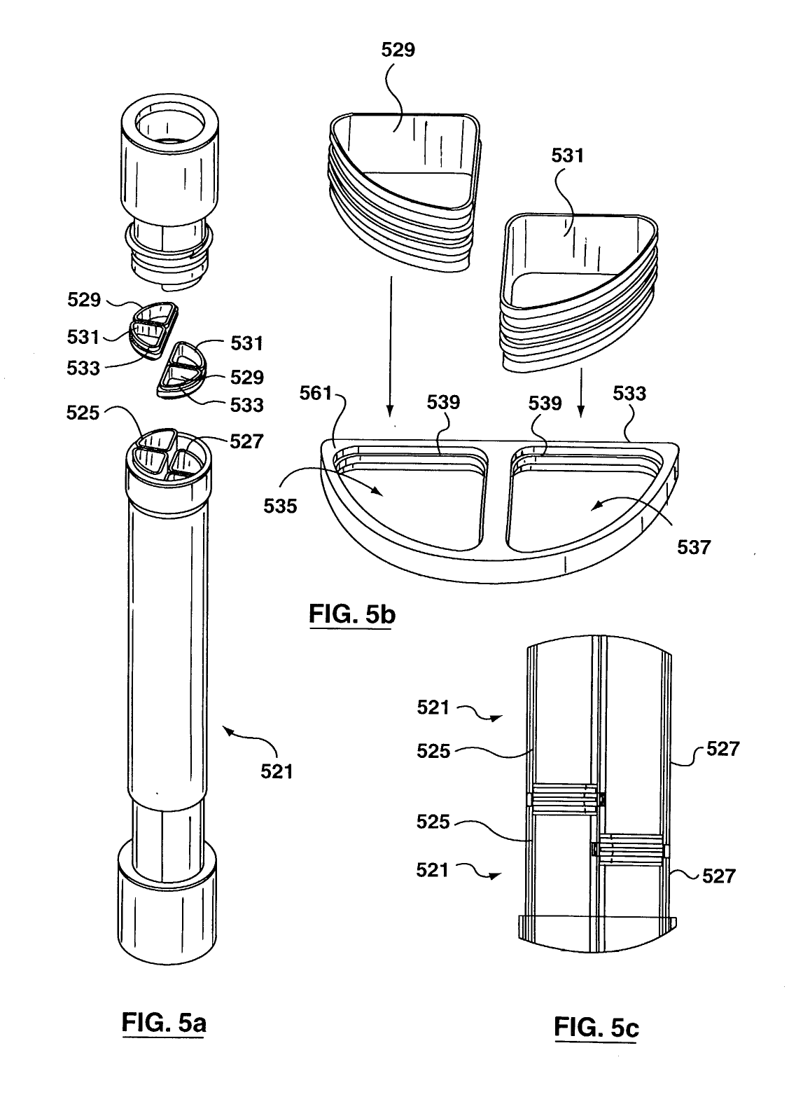

Two alternative examples of seal are shown for engaging, that is, seating within, retainer 533. In FIGS. 7a, 7b and 7c, a quarter-pie shaped seal 543 has an internal peripheral arcuate face 547 that, when installed, faces, and defines a portion of the flow passageway for, the fluid to be transported. On the opposite, or back face, seal 543 has a pair of outwardly protruding external ribs 549, defining a square shouldered rebate between them sized to engage ridge 539 of retainer 533. To either longitudinal side of ribs 549, seal 543 has a pair of pipe-wall engaging lands, 551. The skirts formed by the distal edges 553 of lands 551 are flared outward a small amount (for example, about 4 degrees). In use, engagement with the mouth of a similarly shaped tube will necessitate inward deflection of the flared ends, forming a snug interference fit. Alternatively, as shown in FIGS. 7d, 7e and 7f, a quarter-pie shaped seal 553 is generally similar to seal 543, having a relief 555 for engaging ridge 539, but rather than having square shoulders, have tapered shoulders 557 leading to lands 559. In use seal 543, or 553, is mated with each aperture in retainer 533, and seated on the end of one of the tube pairs. The flat faces 561 of retainer 533 bear against the end faces of the respective tube pairs.

It is not necessary that equal pairs of tubes be stepped to give an indexing feature to the assembly. For example, rather than a pair, a single pipe could be advanced to give a unique assembly orientation. A number of possible alternative configurations are possible. An advantage of the example shown in FIGS. 7a, 7b and 7c is that it permits use of a single type of symmetrical end seal, in a single type of retainer. That is, fewer parts need to be stocked, and the parts that are stocked can be inserted with either face up or down to achieve the same fit.

### Alternative Embodiments of Conduit Members

In the alternative side-by-side embodiments of FIGS. 8a to 16e, none of the cross-sectional areas of any of the individual tube sections overlaps the area of any other, as would be otherwise be the case in a nested pipe arrangement. Further, it is a matter of mathematical calculation that the centroid of the cross-sectional area of any of the tube sections of the preferred embodiment of FIG. 8a, or the alternative embodiments of FIGS. 8b to 16e, lies outside the cross-sectional area of any of the other tubes that are in side-by-side relationship. The hydraulic diameter, Dₕ of a passageway is given by the formula:

Dh=4A/P

Where:

A=Cross sectional area of the passage; and

P=Perimeter of the passage.

In FIG. 8a, the hydraulic diameter of the tubes is less than the quotient obtained by dividing the perimeter of the particular tube by π.

In the alternative embodiment of FIG. 8b, a pipe assembly 650 has a pair of semi-cylindrical tubes 652 and 654 nested in a side-by-side manner within an outer casing 656. Each of semi-cylindrical tubes 652 and 654 has a tube wall that has a flat portion 658, and an arcuate portion 660, joined at smoothly radiused corners to form a semi-circular D-shape as shown. As above, tubes 652 and 654 as seamless steel tubes of a known pressure rating that have being roll formed through progressive dies to achieve the smoothly radiused D-shape shown.

The tube walls of tubes 652 and 654 each have an internal surface 662 or 664 defining an internal passageway 666, 668 along which fluids can be conducted. Each passageway has a cross-sectional area, neither cross-sectional area overlapping the other, and neither having a centroid lying within the cross-sectional area of the other. The external surfaces of flat portions 658 of tubes 652 and 654 engage along a planar interface lying on a diametral plane of casing 656. As above, casing 656 is shrink fit about tubes 652 and 654, creating a tensile pre-load in casing 656, and a compressive pre-load in arcuate portions 660 of tubes 652 and 654. A seal of suitable shape is used in place of seal 530 described above at the connections between successive tube assemblies.

In this kind of two tube embodiment, water (or another suitable working fluid) can be used as the working fluid to drive the downhole pump, such that one passage such as passage 668 carries water under pressure down to the pump, and the other passage 666 carries both the production fluid and the return flow of the water used to drive the pump. Such a system may tend to require a relatively large supply of clean working fluid. The working fluid and the production fluid will tend to need to be separated at the surface, so a significant settling or other separation system may tend to be required.

In a two tube arrangement, it is not necessary that the two tubes have cross-sections of equal area. For example, as shown in pipe assembly 670 of FIG. 8d, depending on the pressures in the tubes, it may be desired that the pressure supply flow (in the downward passage) be rather smaller than the return flow (in the upward passage), which carries both the working fluid and the production fluid. Since line losses vary with the square of mean flow velocity, it may be desired for the smaller volumetric flow to be carried in a smaller tube. Hence down flow tube 672 is smaller in cross-sectional area than return flow tube 674. That is, the corresponding flat portions 676 and 678 of tubes 672 and 674 do not have a diametral surface, but rather run along, and have an abutting interface at, a chord 675 offset from the diametral centerline 679.

Although the offset in FIG. 8d is achieved along an offset chord, this need not be the case. As shown in FIG. 8e, a pipe assembly 680 has an outer casing 682 shrink fit about two internal tubes 684 and 686. The smaller of these, tube 686, has the shape of a pie shaped piece, with radiused corners, subtending a minor arc of the circular inner face of casing 682. The large piece, 684, has the shape of the remainder of the pie, with smoothly radiused comers. The side portions of tubes 684 and 686 meet along planar interfaces that extend radially relative to the axial centerline of casing 682.

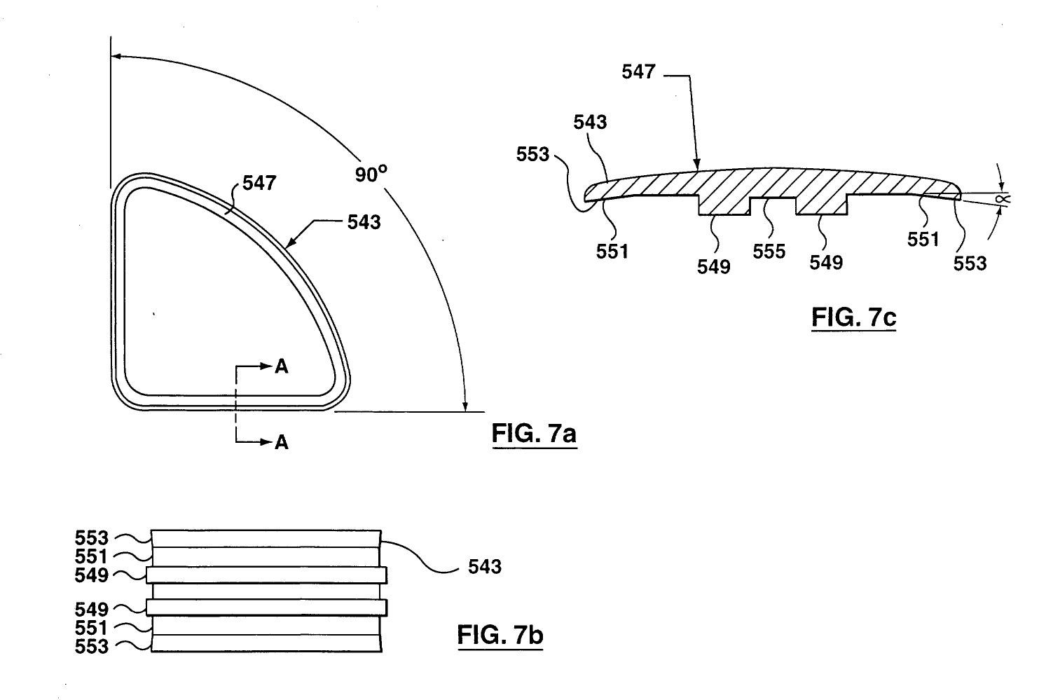

In the alternative embodiment of FIG. 9a, a pipe assembly 690 has a set of three tubes 691, 692 and 693 of equal passage size. Each of tubes 691, 692 and 693 occupies one third of the area within shrink fit casing 694, and has side wall portions 696 and 697 that extend radially outward from the center of casing 694 and an arcuate circumferential portion 695 that is placed in mating engagement with casing 694. The inner face 698 of each of tubes 691, 692 or 693 defines an internal passageway, 699, having a cross sectional area that is roughly 120 degrees of arc, or ⅓ of the area of casing 694, less the thickness of the walls forming the periphery of passageway 699.

A three pipe embodiment of pipe assembly is shown in FIG. 8c as 700. In a three pipe embodiment, one pipe can be used, for example, to carry hydraulic fluid under pressure, such as to drive a downhole hydraulic pump; a second pipe can provide the return line; and the third pipe provides the conduit by which production fluid is conveyed to the surface. This may tend to avoid mixing of the return and production fluid flows in the return of a two pipe system, and may also tend to avoid the need for a large settling or separation system at the discharge end of the production floe pipe. Alternatively, the working fluid can be fed down one pipe, production fluid and the return of the working fluid can be by a second of the three pipes, and the third pipe can carry electronic cables.

In pipe assembly 700 a first roll-formed tube of known pressure rating is shown as 701. It is roughly semi-circular in shape, with radiused comers. It has a flat portion 702 and an arcuate portion 703 for mating engagement within the round cylindrical inner surface of a shrink fit casing 704. Second and third tubes 706 and 708 have the shape of quarter pie pieces, each with radiused comers. Each has first and second flat 710, 711 portions meeting at a right angled radiused comer, the flat portions extending more or less radially outward to meet an arcuate portion 712 suited for engaging an arc of the circumferential inner face of casing 704. The various flat portions of tubes 701, 706 and 708 meet on radial planes of casing 704. Each of tubes 701, 706 and 708 has an internal face defining the periphery of a passageway, 714, 715, 716 respectively, each passageway having a cross-sectional area defined within that periphery.

The various pipes need not necessarily be of the same size, particularly if the flow of working fluid for driving the pump is under high pressure, but relatively low flow. It may be preferable for the cross-section of the passage for conveying the production fluid, namely 714 to be larger than the others, as shown in the embodiment of FIG. 8c, particularly since line losses tend to vary in turbulent flow as the square of the mean velocity of the fluid, and the mean velocity of the fluid is determined by dividing the volumetric flow by the passage area. Given that the pressure and return lines are carrying very nearly the same volumetric flow rate of a largely incompressible fluid (differing only to the extent of the pressure difference multiplied by the bulk modulus of compression of the fluid at the given operating temperature), pressure and return passages 715 and 716 can most conveniently be made the same size, as shown in this embodiment.

As with the example of FIG. 8c, the pie-shaped tubes need not be of equal size. Thus, in FIG. 9b, a pipe assembly 720 has an external casing 722 and three internal tubes 724, 725 and 726, which are in other ways similar to tubes 691, 692 and 693, except that tube 724 subtends a pie shape of about ⅙ of casing 722, tube 725 subtends a pie shape of about ⅓ of casing 722, and tube 726 subtends about ½ of casing 722. In this case, if for example a gas under pressure such as air or steam, or an inert gas, is used as the driving fluid to operate a pneumatic pump, the return line, at lower pressure, may need to have a larger cross-sectional area to keep gas velocity somewhat lower.

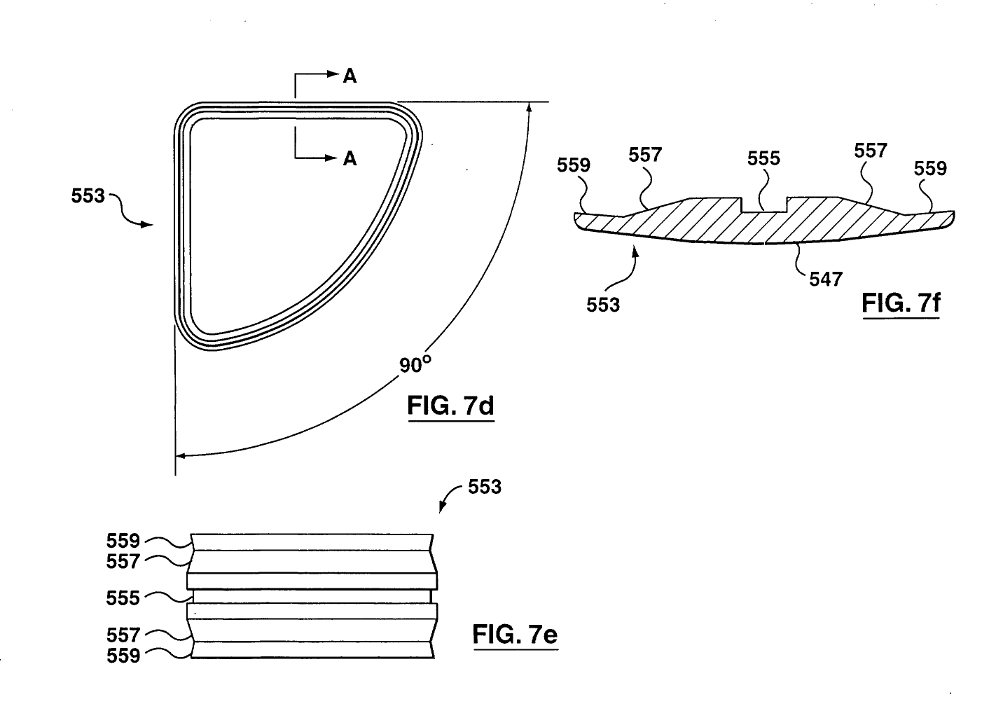

FIG. 10a shows a pipe assembly 730 having a set of six equal side-by-side pie-shaped tubes 732 contained within an external cylindrical casing 734. Each of tubes 732 is a roll-formed tube similar to tube 726, above. As the number of tubes in the bundle increases, and given the need for a reasonable radius on the roll-formed tubes, the size of the gap 733 at the center of the bundle increases, and becomes a significant passageway for cables or other wiring as may be desired. A central tube can also be obtained as shown in FIG. 10b in which a tube assembly 735 has a cluster of smoothly radiused, side-by-side hexagonal tubes 736 retained within an external casing 738. In such an assembly each of the available tubes can be used for a different function, or, alternatively, the operator can select two or more hexagonal tubes for one purpose, another pair for another purpose, and the remaining two for yet some other purpose or purposes. The selection of tubes is associated with the provision of an appropriate downhole manifold and well-head manifold, and suitable seals between successive the pipe assembly sections to maintain segregation between the various passageways.

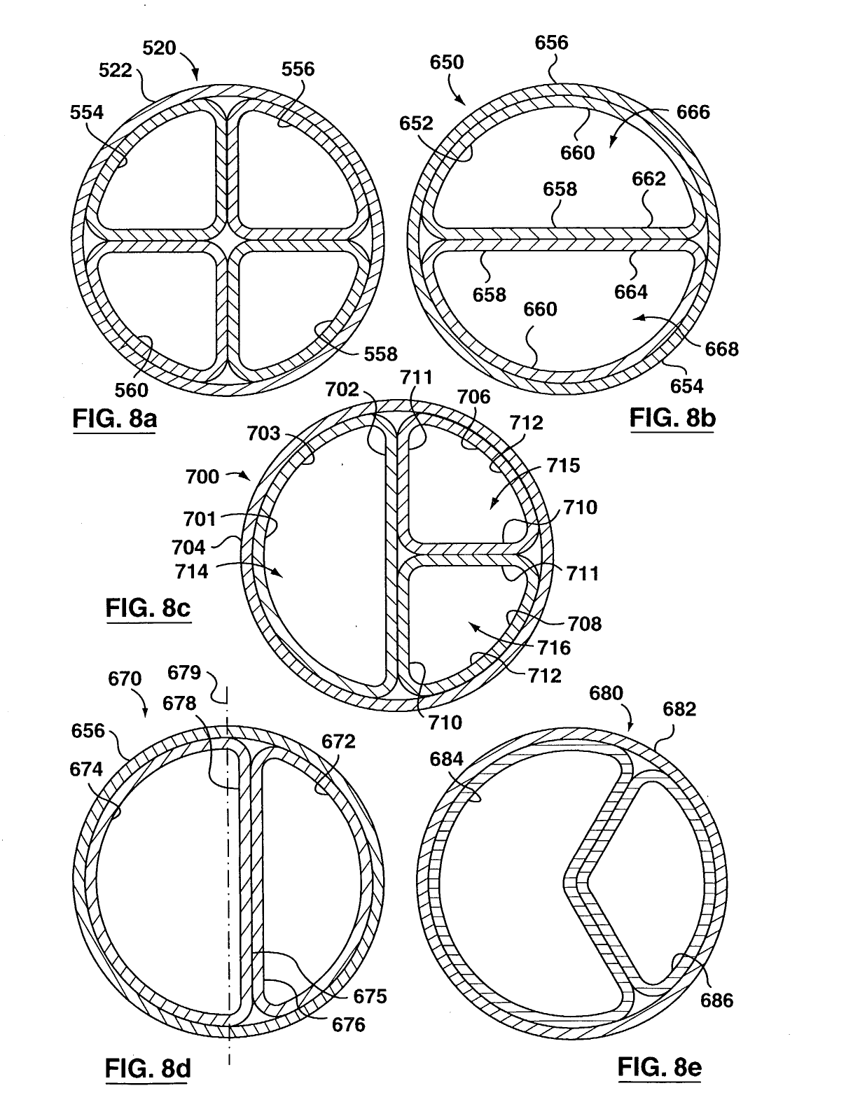

FIGS. 11a and 11b show alternative configurations to that of FIG. 8c. In FIG. 11a a pipe assembly 740 has an external casing 742 and three internal tubes 744, 745 and 746, each having an internal wall defining the periphery of an internal passage. Tubes 745 and 746 are mirror images of each other, and tube 744 is rather larger such that the flat interface of tube 744 with tubes 745 and 746 lies along a chord 748 offset from the diametral plane 747 of casing 742. Tube 744 occupies more than half of the inner cross-sectional area of casing 742. FIG. 11b shows a pipe assembly 750 having a casing 752 and three internal tubes 754, 755 and 756, each having an internal wall defining the periphery of an internal passage. Tubes 755 and 756 are mirror images of each other, and tube 754 occupies the remainder of the cross-sectional area not occupied by tubes 755 and 756. The flat interface of the external surface of the flat portion of tube 754 with the external surface of flat portions of tubes 755 and 756 lies along a chord 758 offset from the diametral plane 757 of casing 752 such that tube 754 occupies less than half of the cross-sectional area of casing 752. FIG. 11c shows an embodiment of a four tube variation of the embodiments of FIGS. 11a and 11b. In this instance a tube assembly 760 has a retainer in the nature of an external casing 762 and four internal roll-formed tubes 764, 765, 766, and 767. Tubes 764, 765, 766 and 767 are of unequal sizes. The planar interface between the external surfaces of tubes 764 and 765 lies on a chord that is offset from a diametral plane 768 by a step distance α, and the interface between the external surfaces of tubes 766 and 767 is offset from diametral plane 768 by a step distance β. In the most general case, β is not equal in magnitude to α.

FIG. 11d shows a further variation of an embodiment of a four tube pipe assembly 770, having a casing 772 and four tubes 774, 775, 776, and 777. Tubes 774, 775, 776 and 777 are of unequal sizes. The planar interface between the external surfaces of tubes 774 and 775 lies on a chord that is offset from a diametral plane 778 by a step distance ψ. Tubes 776 and 777 are pie shaped, and are unequal in size.

In each case, by providing tubes in a side-by side configuration, overall resistance to fluid flow in the assembly may tend to be reduced over that achievable with concentric nested pipes. It may tend also to reduce the need for spiders or other means for maintaining specific spacing of the pipes that might otherwise be required for concentric pipes. That is, the pipes are formed such that they can lie side-by-side within the outer retainer. The shape of the tube walls can be adjusted by roll forming to achieve planar interfaces between the internal pipes to give hydraulic diameters that are less than the result obtained by dividing 4A/π, while continuing to use pipes that have either flat portions or concave arcuate portions. The examples described thus far do not have convex peripheral portions, such as would occur with a re-entrant curve. In a re-entrant curve, (a) the local radius of curvature extends away from the wall portion toward a local focus point and (b) the local focus point of the radius of curvature lies outside the cross-sectional area of the particular pipe.

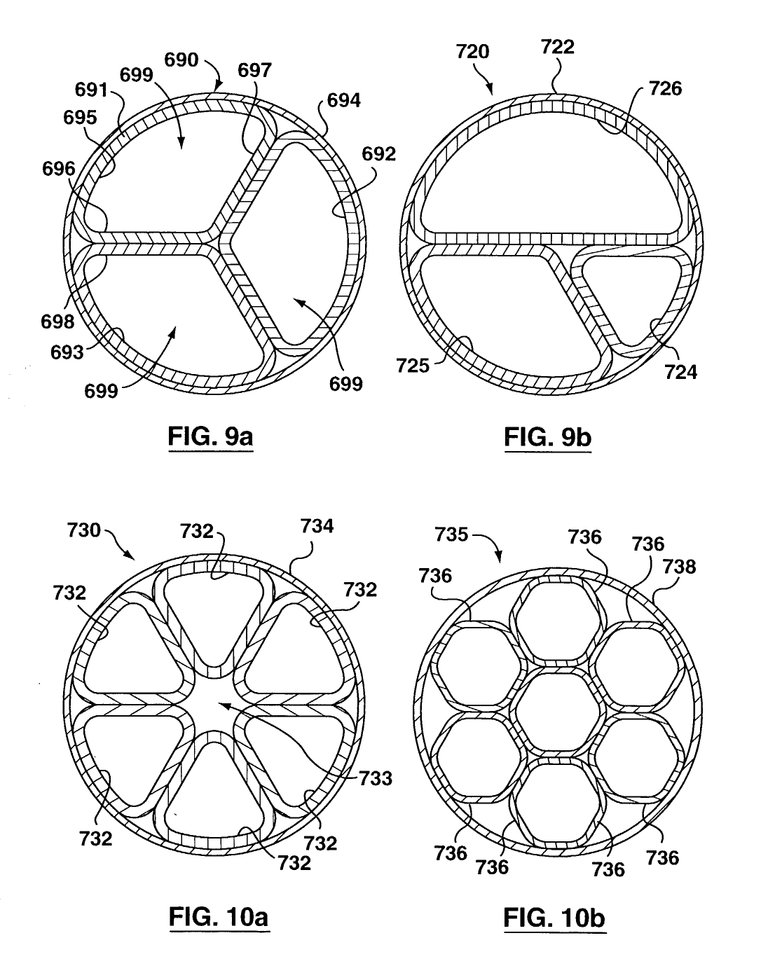

In some instances it may be acceptable merely to place round pipes side-by-side within a casing. In FIG. 12a a two-tube pipe assembly is shown as 780. It has a round cylindrical outer casing 782 and a pair of round, internal tubes 783 and 784 mounted within casing 782 and tangent to the inside surface of casing 782. Each of tubes 783 and 784 has a known pressure rating, and each has an internal passageway 785, 786 having a periphery and a known cross-sectional area. The remaining spaces 787, 788 between the internal wall of casing 782 and the outer wall surfaces of tubes 783 and 784 can be used to carry services such as electrical cabling. In the alternative, if casing 782 has a known pressure rating, fluids under pressure can be carried in the passageways formed by spaces 787 and 788, although they have less favourable hydraulic diameters and cross-sectional shapes than might otherwise be desired.

FIG. 12b shows a pipe assembly 790 that differs from pipe assembly 780 in that it has an outer casing 792 housing a set of three internal tubes 793, 794 and 795 of round cylindrical section, and of somewhat smaller diameter than tubes 783 and 784. Once again, casing 792 can be a pipe of known pressure rating, and the interstitial spaces 796, 797, and 798 can be used to carry electrical or other services. FIG. 12c shows a further variation of pipe assembly 800, that differs from assemblies 780 and 790 by having a casing 802 and four circular internal tubes 803, 804, 805 and 806.

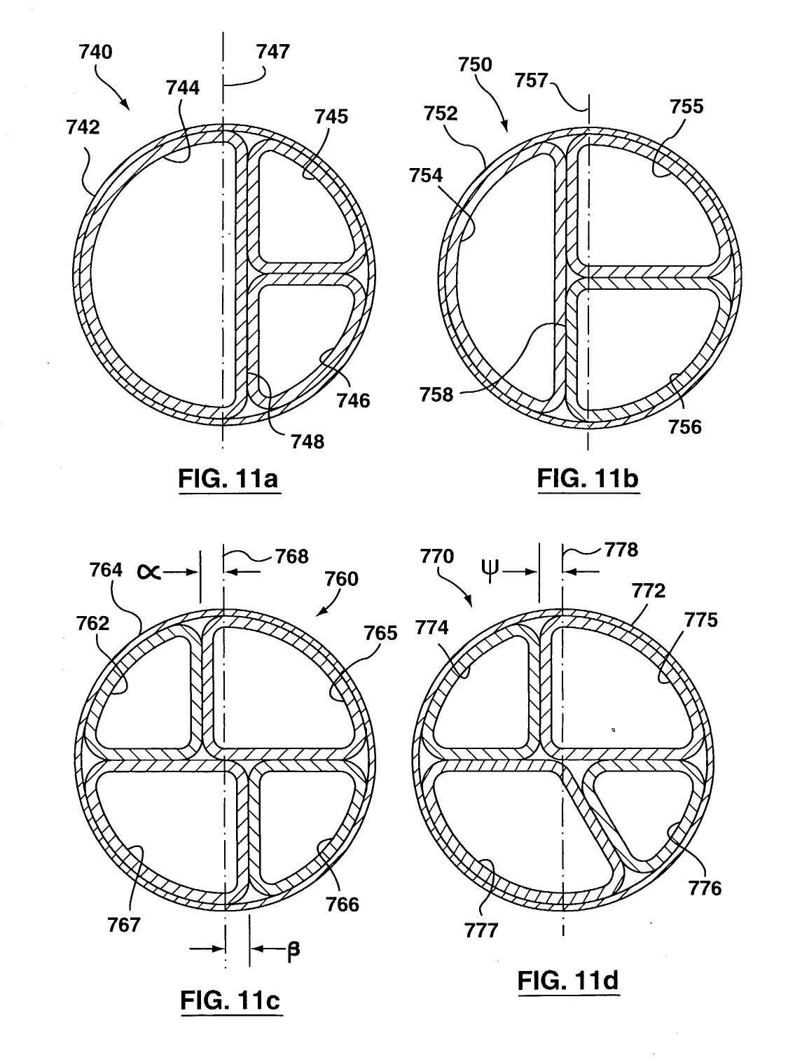

In some cases it is also possible to improve hydraulic properties of a pipe assembly even when one or more tubes in a pipe bundle pipe have local portions that have re-entrant, or convex walls. FIG. 13a shows a three-tube pipe assembly 810 that has a shrink fit round cylindrical outer casing 812. A central round cylindrical pressure rated seamless steel tube 814 is located concentrically to casing 812. A pair of half-doughnut, or kidney shaped, tubes 815 and 816 are contained within casing 812 and form a sandwich about central tube 814. Each of tubes 815 and 816 has a tube wall that has an outer arcuate portion 817 of a circular arc suitable for engaging the inner surface of casing 812, and an inner arcuate portion 818, opposed to outer arcuate portion 817, that has an external surface formed on an arc suitable for engaging the outer surface of circular cylindrical tube 814. Tubes 815 and 816 also have first and second radial portions 819 and 820 that are joined to portions 817 and 818 to form a hollow, closed, kidney shape as noted, the vertices being smoothly radiused. The inner surface of this kidney-shaped wall defines the periphery of internal passage 821. Tube 816 is of the same construction as tube 815, the two tubes meeting at the planar external faces of portions 819 and 810 that lie on a diametral plane 822 of casing 812. In this instance, portion 818 is convexly curved relative to passage 821. That is, the local radius of curvature extends away from passage 821 to a local focus of the local radius of curvature that lies outside passage 821. However, the centroid 823 of the cross-sectional area of passage 821 lies within passage 821, rather than falling within the cross-sectional area of the internal passage 824 of central tube 814.

The configuration of FIG. 13a, in effect, splits the annular space between central tube 814 and casing 812 in half across the diameter of casing 812, rather than by trying to nest a third pipe concentrically between central tube 814 and casing 812. The resulting passages will tend to have a combined area that is greater than can be achieved with concentric tubes of the same wall thickness, and will have larger hydraulic diameters, with a consequent reduction in resistance to fluid flow.

It is not necessary that tubes 815 and 816 be of equal size. Pipe assembly 825 of FIG. 13b is similar to pipe assembly 810, but rather than have kidney shaped pipes of equal size, assembly 825 has first and second pipes 826 and 828 of unequal size, meeting on radial interfaces.

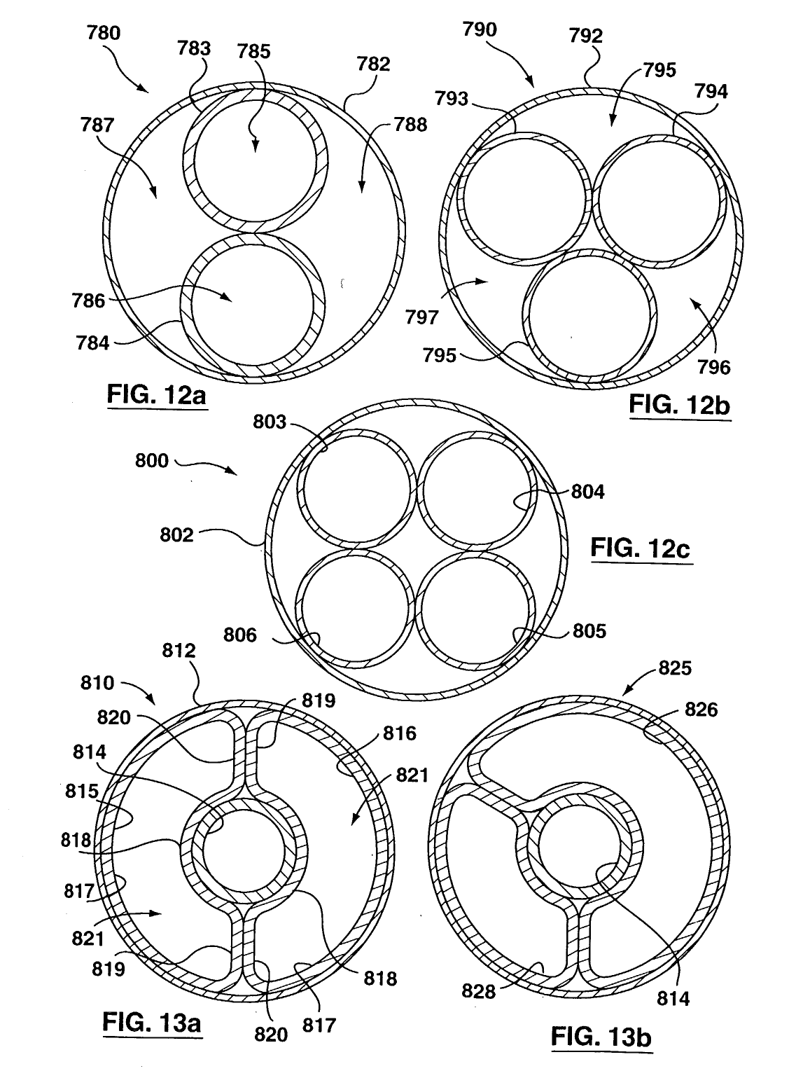

FIG. 14a shows a cross-section of another, four-tube, modular pipe assembly 830, having a casing 832, a central tube 834 mounted concentrically within casing 832, and three equal tubes 836, 837 and 838 clustered about central tube 834 and meeting at radial planar interfaces on 120 degree centers. Each of tubes 836, 837 and 838 occupies a sector that is a third of the annular space between casing 832 and central tube 834. As noted above, it is not necessary that the tubes be of equal sizes. FIG. 14b shows a cross-section of a modular pipe assembly 840 having a casing 842, a round cylindrical central tube 844, and three tubes of different sizes 846, 847, and 848, describing, respectively, 75, 120 and 165 degrees of arc. In general, the arcuate extent of the tubes may be chosen, with all sizes different, two the same, or three the same as may be desired or convenient.

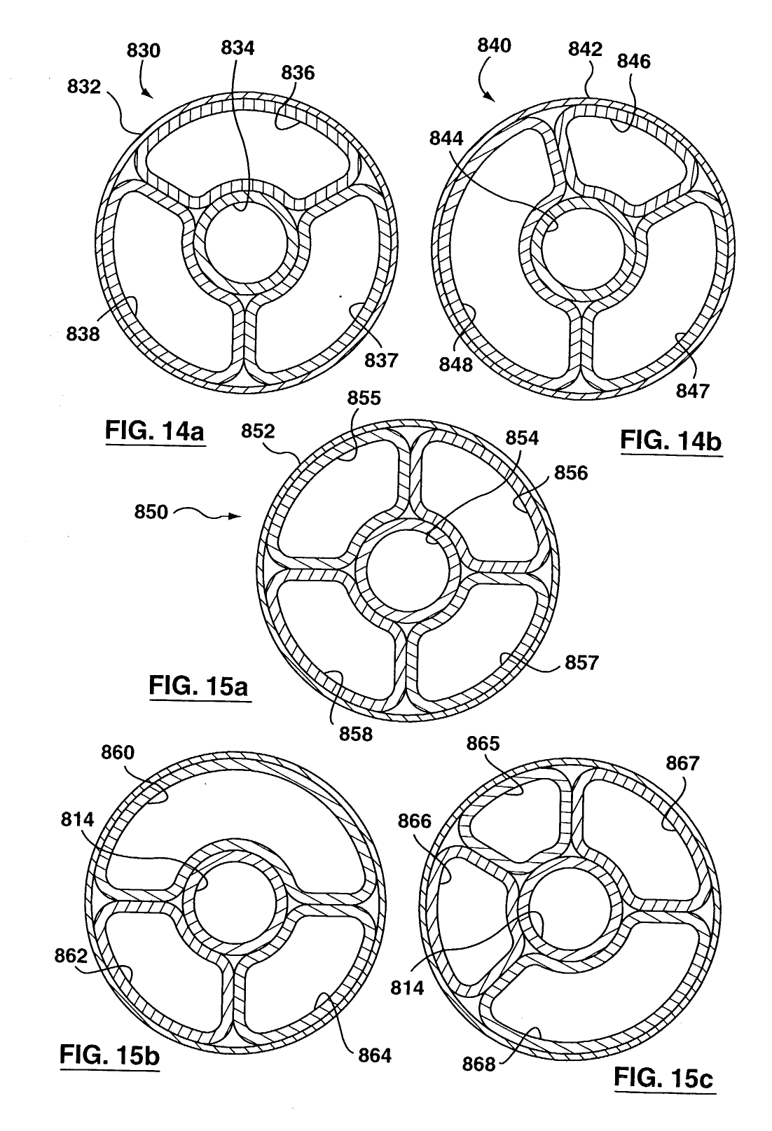

FIG. 15a shows a cross-section of a five-tube modular pipe assembly 850 having a casing 852, a central tube 854, and four equal sectoral tubes 855, 856, 857 and 858, each occupying a quarter-sector space. FIG. 15b shows a similar four-tube arrangement but with a single semi-sectoral tube 860, and a pair of quarter-sectoral tubes 862 and 864. FIG. 15c shows yet another alternative five-tube arrangement, in which each of sectoral tubes 865, 866, 867 and 868 occupies a different sized sector, being respectively 60, 75, 90 and 135 degrees of arc being radial interfaces. In general, all sizes may be different, or two, three or four sectors can be the same size as may be desired.

In each of the examples of FIGS. 13a, 13b, 14a, 14b, and 15a, 15b and 15e, the concentric central tube, such as tube 814, is maintained in position relative to the casing by the radial wall of the surrounding tubes. That is, the shape of the tubes occupying the annular space between the casing and the central tube is such as to act in the manner of a spider to maintain the relative position of the central tube to the casing, although the central tube and the casing do not contact each other directly. The same is true of the central hexagonal tube in the bundle of hexagonal tubes shown in FIG. 10b.

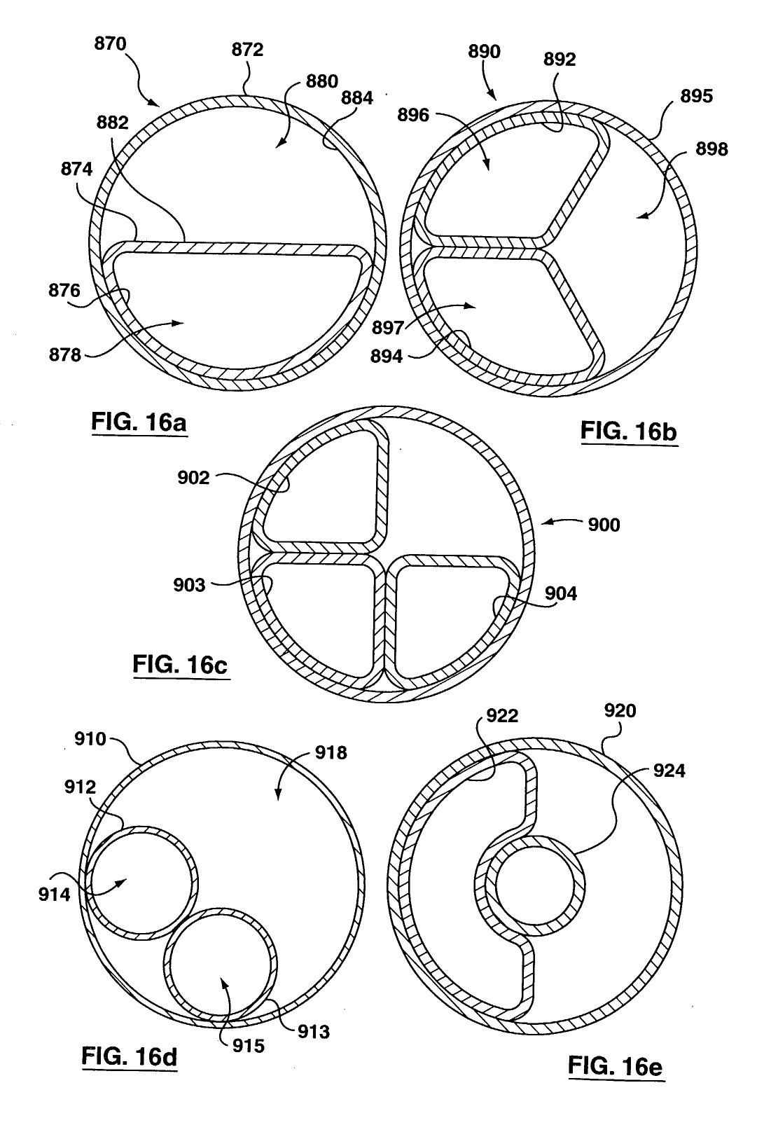

FIG. 16a shows a modular pipe assembly 870 having an external casing 872 that is a seamless steel tube of known pressure rating. A roll-formed seamless steel tube 874, also of known pressure rating, is formed into a D-shape, or hollow semi-circular form. The outer wall surface of arcuate portion 876 of tube 874 is of a radius to mate with the inner surface of casing 872. When located as shown in FIG. 16a, a first passageway 878 is defined within the inner wall surface of tube 874, and a second passageway 880 is defined between the outer surface of straight portion 882 of tube 874 and the remaining half 884 of the inner surface of casing 872 that is not engaged by portion 876 of tube 874. The result is a two-tube configuration generally similar to that shown in FIG. 8b and described above. Tube 874 can be held in its nested position within casing 872 by a bonding agent, or by welding, or by other mechanical means that does not impair the integrity of the passageways.

FIG. 16b shows a modular pipe assembly 890 that is similar to assembly 870, but has two nested roll formed tubes 892 and 894, each occupying a sector roughly equal to ⅓ of the space within pressure rated casing tube 895, such that three side-by-side passages 896, 897 and 898 are formed. This yields a three passageway result similar to the tube bundle configuration of FIG. 9a. FIG. 16c shows a modular pipe assembly 900 that is again similar to assemblies 870 and 890, but in this case has three internal roll-formed tubes 902, 903 and 904 each occupying about a quarter sector of the space defined within outer pressure rated tube 905. This yields a side-by-side four passageway result similar to that of FIG. 8a. Sectoral tubes such as 892 and 894, or 902, 903 and 904 can be used singly or in equal or unequal combinations as may be suitable for a given application.

FIGS. 16d and 16e represent further alternatives to the assemblies of FIGS. 16a, 16b and 16c. In FIG. 16d, an outer pressure rated tube 910 has a pair of round circular tubes 912 and 913 nested side-by-side eccentrically within tube 910. This yields a pair of relatively small, round cylindrical passages 914 and 915 within tubes 912 and 913, and a larger, irregularly shaped passage 918, in the remaining space within the inner wall of tube 910. Tubes 912 and 913 can be bonded or welded in place, or can be held in place by other mechanical means, such as a bracket or spider, that does not impair the integrity of the passageways. FIG. 16e uses an outer pressure rated tube 920, a kidney shaped tube 922 nested within outer tube 920, and a central tube 924 nested against tube 922, concentric with outer tube 920, yielding a result generally similar to that of FIG. 13a.

An advantage of the alternative embodiments of FIGS. 16a-16e, is that by omitting one of the internal tubes of the analogous cross-sections of FIGS. 8a, 9a, 8b, 12c, or 13a (or of others of the above described cross-sections as may be suitable) the cross-sectional area otherwise occupied by the wall thickness of the omitted tube is made available for carrying fluids or other services. For a given volumetric flowrate, mean velocity is determined by the available cross-sectional area. Losses vary as the square of the mean velocity of the fluid, and hydraulic diameter also improves. For example, a 6 inch outer pipe with a 0.25 inch wall thickness, and an inner tube of 0.217 inch wall thickness, the potential increase in area for a semi-circular tube is significant. In each case, notwithstanding that one or several pipes are nested within another, the relationships of the passageways remains a side-by-side relationship, rather than a concentric relationship.

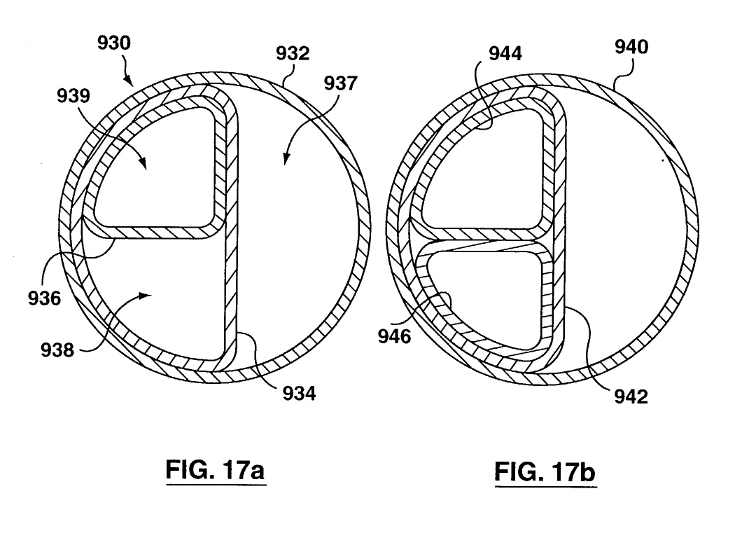

FIG. 17a shows a modular pipe assembly 930 having an outer conduit in the nature of a seamless steel tube 932 of known pressure rating. As in the alternative embodiment of FIG. 16a, a second conduit member in the nature of a roll formed seamless steel tube 934 formed in the shape of a semi-circle is located within the hollow interior region defined by the inside surface of tube 932, the outer surface of the arcuate portion of tube 934 being formed to engage a portion of the inner surface of the continuous peripheral wall of tube 932. In addition, a third conduit member, in the nature of a seamless steel tube 936, roll formed into a shape of a quarter pie piece, more or less, is located within tube 934. Tube 936 has an arcuate outer surface shaped to engage a portion, roughly half, of the inside face of the arcuate portion of the peripheral wall of tube 934. and a flat portion whose outside surface lies against a portion of the inside face of the flat portion of tube 934. As shown, this configuration of tubes defines three parallel side-by-side passages, 937, 938 and 939. Passage 937 is defined, or bounded, by half of the inside arcuate face of outer tube 932 and the outer face of the back, or straight portion of tube 934. Passage 938 is defined, or bounded, by half of the inner surface of the straight portion of tube 934, half of the arcuate inner surface of tube 934, and the outer surface of the radial leg portion of the wall of tube 936 that extends at right angles to the diametral flat portion of tube 934. Passage 939 is defined, or bounded, by the interior face of the peripheral wall of tube 936.

The alternative embodiment of FIG. 17b is similar to that of FIG. 17a in having a D-shaped tube 942 located within a circular tube 940, but differs to the extent that rather than having a third tube nested within tube 940, third and fourth tubes 944 and 946 are located in side-by-side arrangement within the D-shaped cavity of tube 940. As shown, tubes 944 and 946 are unequal. In the general case of either the embodiment of FIG. 17a or FIG. 17b, the pipes need not be equal in size, need not have right angled corners, and need not have straight sides lying on diametral chords of outer tube 942, but may have proportions suited for the flows to be carried, may lie on sectors of non-square angles, and may have side portions that lie on chords offset from the diameter of the respective tubes.

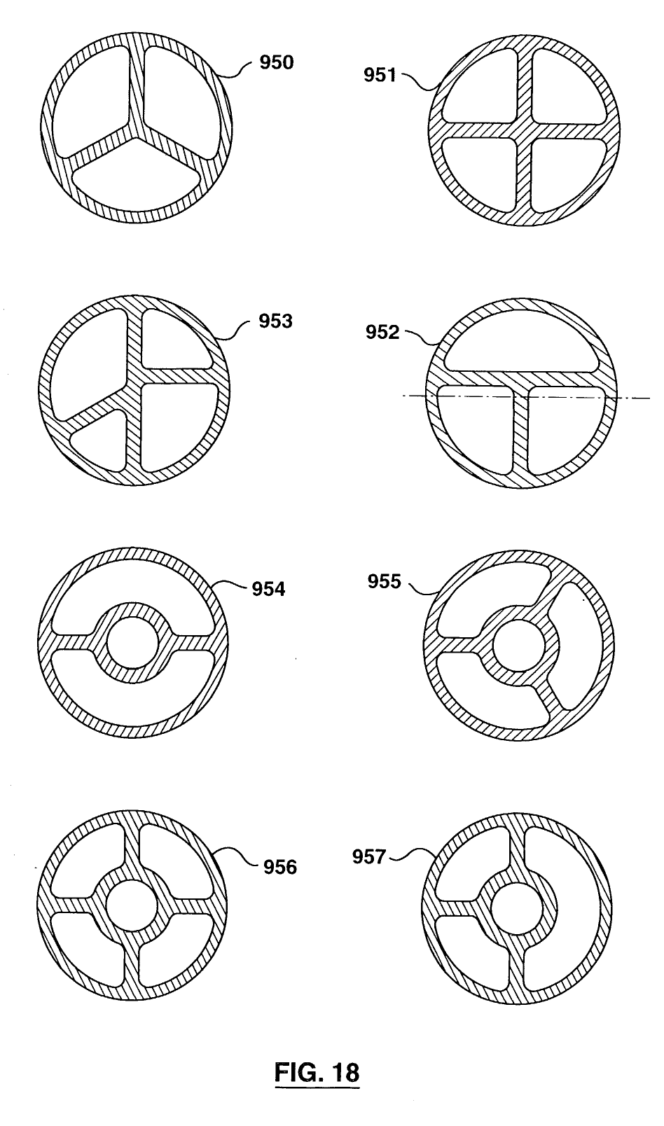

FIG. 18 shows eight variations of cross-sections of extruded tube that could be used as an alternative to the multi-tube assemblies described above, the sections having a suitable pressure rating. The proportions of the pipe walls and webs are not drawn to scale. In principle it is possible to extrude tubes corresponding to any of the sections described above. Member 950 corresponds to assembly 690. Member 951 corresponds to assembly 520. Member 522 corresponds to assembly 750. Member 953 corresponds to assembly 770, and is intended to represent the general case of any four passage duct. Member 954 corresponds to assembly 810. Member 955 corresponds to assembly 830. Member 956 corresponds to assembly 850, and member 957 corresponds to the assembly of FIG. 15b, or more generally, a four passage duct that includes a central tube.

Various embodiments of the invention have now been described in detail. Since changes in and or additions to the above-described best mode may be made without departing from the nature, spirit or scope of the invention, the invention is not to be limited to those details, but only by the appended claims.

We claim:

1. A modular well pipe assembly comprising:
a pipe wall structure having at least first and second passages defined side-by-side therein;
said pipe wall structure having a first end and a second end;
said first and second ends having respective first and second end couplings matable with other end couplings of modular pipe assemblies of the same type;
said end fittings having alignment fittings for aligning said first and second passages with corresponding first and second passages in other modular pipe assemblies of the same type.

2. The modular pipe assembly of claim 1 wherein said pipe wall structure includes a hollow outer casing and at least first and second conduits for carrying fluids mounted side-by-side within said casing.

3. The modular pipe assembly of claim 1 wherein:
one of said end couplings has a seal mounted thereto;
said seal has porting defined therein corresponding to said passages;
said seal is placed to maintain segregation between said passages when said modular pipe assembly is joined to another modular pipe assembly of the same type.

4. The modular pipe assembly of claim 3 wherein said end coupling is engageable with a mating modular pipe assembly to compress said seal.

5. The modular pipe assembly of claim 1 wherein:
said pipe wall structure includes a first conduit member and a second conduit member mounted within said first conduit member;
said first conduit member has a continuous wall, said continuous wall having an inner surface defining a periphery of an internal space;
said second conduit member occupies a first portion of said internal space of said first conduit member and leaves a remainder of said internal space of said first conduit member;
said second conduit member having a continuous wall, said continuous wall of said second conduit member having said second side by side passage defined therewithin;
said continuous wall of said second conduit has an external surface;
a portion of said external surface of said second conduit member being formed to conform to a first portion of said inner surface of said first conduit member, and being located thereadjacent;
said first passage being defined within said remainder of said internal space of said first conduit member.

6. The modular pipe assembly of claim 5 wherein said inner surface of said first conduit member has a second portion bounding a portion of said first passage.

7. The modular pipe assembly of claim 5 wherein:
said inner surface of said first conduit member has a second portion;
said external surface of said second conduit member has a second portion; and
said second portion of said inner surface of said first conduit member and said second portion of said external surface of said second conduit member co-operate to bound at least a portion of said first passageway.

8. The modular pipe assembly of claim 5 wherein:
said first conduit member has a round cylindrical cross-section; and
said second conduit member continuous wall has a portion lying along a first chord of said cylindrical cross-section.

9. The modular pipe assembly of claim 8 wherein said chord is a diametrical chord.

10. The modular pipe assembly of claim 8 wherein said second conduit member has another portion lying along a second chord of said cylindrical cross-section.

11. The modular pipe assembly of claim 10 wherein said second conduit member occupies a sector of said cylindrical cross-section between said first and second chords.

12. The modular pipe assembly of claim 5 wherein:
said pipe wall structure includes a third conduit member;
said third conduit member has a continuous wall having a third side-by-side passage defined therewithin;
said third conduit member has an external surface;
a portion of said external surface is shaped to conform to, and is located adjacent to a second portion of said inner surface of said first conduit member.

13. The modular pipe assembly of claim 5 wherein:
said pipe wall structure includes a third conduit member;
said third conduit member has a continuous wall having a third side-by-side passage defined therewithin;
said second conduit member has an internal wall surface;
said third conduit member continuous wall has an external surface;
a portion of said external surface of said third conduit member is shaped to conform to, and is mounted against, a portion of said internal wall surface of said second conduit member.

14. The modular pipe assembly of claim 1 wherein:
said pipe wall structure includes a first conduit member, a second conduit member, and a third conduit member; and
said second and third conduit members are mounted side-by-side within said first conduit member.

15. The modular pipe assembly of claim 14 wherein said second conduit member has a circular cross-section.

16. The modular pipe assembly of claim 14 wherein said second and third conduit members have circular cross-sections.

17. The modular pipe assembly of claim 14 wherein a fourth conduit member is mounted within said first conduit member.

18. The modular pipe assembly of claim 17 wherein:
said first conduit member has a circular internal wall surface; and
said second, third and fourth conduit members have circular cross sections and are mounted in tangential engagement with said circular internal wall surface of said first conduit member.

19. The modular pipe assembly of claim 18 wherein each of said second, third and fourth conduit members is tangent to at least one of the others.

20. The modular pipe assembly of claim 14 wherein at least one of said second and third conduit members is hexagonal in cross-section.

21. The modular pipe assembly of claim 14 wherein at least one of said second and third conduit members is pie shaped in cross-section.

22. The modular pipe assembly of claim 21 wherein said pie shape is chosen for the set of pie shapes consisting of:
(a) a half of a pie;
(b) a third of a pie;
(c) a quarter of a pie;
(d) a sixth of a pie.

23. The modular pipe assembly of claim 1 wherein:
said pipe wall structure includes a first conduit member and a second conduit member mounted within said first conduit member;
said second conduit member has a continuous wall bounding said second passage;
said second passage having a periphery and a cross-sectional area;
said second conduit member continuous wall has an internal surface defining the periphery of said second passage; and
said second passage has a hydraulic diameter that is less than the dividend obtained by dividing said perimeter by π.

24. The modular pipe assembly of claim 23 wherein said second conduit member is free of convex portions.

25. The modular pipe assembly of claim 1 wherein:
said pipe wall structure includes a first conduit member and a second conduit member mounted within said first conduit member;
said second passage having a perimeter ‘P’, a cross-sectional area A and a hydraulic diameter D_{H};
said second conduit member has a continuous wall having an inside surface defining said perimeter ‘P’ of said second passage; and
A<(P²/4π)

26. The modular pipe assembly of claim 25 wherein said second conduit member is free of convex portions.

27. The modular pipe assembly of claim 1 wherein said pipe wall structure includes:
a first, outer, conduit member having an inner wall surface;
a second, inner, conduit member mounted within said first conduit member, said inner conduit member having an outer wall surface;
said inner wall surface of said outer conduit member and said outer wall surface of said inner conduit member bounding a region intermediate said outer conduit member and said inner conduit member; and
a third conduit member defining a third passage therewithin in side-by-side relationship to said second passage;
said third conduit member being located in said region intermediate said inner wall surface of said outer conduit member and said outer wall surface of said inner conduit member.

28. The modular pipe assembly of claim 27 wherein said third conduit member has an outer wall surface, said outer wall surface of said third conduit member having a first portion engaging said inner wall surface of said outer conduit member and a second portion engaging said outer wall surface of said inner conduit member.

29. The modular pipe assembly of claim 28 wherein:
said first portion of said third conduit member is shaped to conform to a portion of said inner wall surface of said outer conduit member; and
said second portion of said third conduit member is shaped to conform to a portion of said outer wall surface of said inner conduit member.

30. The modular pipe assembly of claim 28 wherein said region between said outer and inner conduits is annular.

31. The modular pipe assembly of claim 28 wherein said inner conduit member is concentric to said outer conduit member.

32. The modular pipe assembly of claim 31 wherein an annulus is defined between said inner and outer conduit members and said third conduit member occupies a sector of said annulus.

33. The modular pipe assembly of claim 32 wherein a plurality of conduit members each occupy sectors of said annulus.
